(19) United States
(12) Patent Application Publication
(10) Pub. No.: US 2007/0295615 A1
(43) Pub. Date: Dec. 27, 2007

(54) SYSTEMS AND METHODS USEFUL IN CONTROLLING OPERATIONS OF METAL ELECTROLYSIS CELLS

(75) Inventors: Xiangwen Wang, Murrysville, PA (US); Robert Hosler, Sarver, PA (US); Gary Tarcy, Murrysville, PA (US)

Correspondence Address: INTELLECTUAL PROPERTY, ALCOA TECHNICAL CENTER, BUILDING C, 100 TECHNICAL DRIVE, ALCOA CENTER, PA, 15069-0001, US

(73) Assignee: Alcoa Inc., Pittsburgh, PA (US)

(21) Appl. No.: 11/767,080

(22) Filed: Jun. 22, 2007

Related U.S. Application Data
(60) Provisional application No. 60/805,937, filed on Jun. 27, 2006.

(51) Int. Cl. G01N 27/416

(52) U.S. Cl. 205/775; 204/401

(57) ABSTRACT

An analysis system for determining one or more operating conditions of a metal electrolysis cell and for facilitating a response is provided. The analysis system comprises a bath probe electrically interconnected to a portable computing device. The bath probe generates signals associated with temperature measurements produced from thermal communication with an electrolysis cell bath. The portable computing device may receive these signals and generate data based thereon. The data may be transformed into operating condition information relating to the electrolysis cell.

### CROSS-REFERENCE TO RELATED APPLICATION(S)

This application claims priority under 35 U.S.C. §119(e) to U.S. Provisional Patent Application No. 60/805,937, filed Jun. 27, 2006, entitled “Systems and Methods Useful in Controlling Operations of Metal Electrolysis Cells”, which is incorporated herein by reference.

### FIELD OF THE INVENTION

The present invention relates to systems and methods for determining the operating conditions of metal electrolysis cells (e.g., an aluminum production electrolysis cell) using a single bath probe and a portable computing device operable to determine one or more operating conditions based on signals received from the bath probe. The present invention also relates to systems and methods for controlling the operation of the metal electrolysis cells based on such determined operating conditions.

### BACKGROUND OF THE INVENTION

A number of metals, including aluminum and magnesium, can be produced by electrolytic processes. One example of an electrolytic process for metal production is the well-known Hall process in which alumina dissolved in cryolite is electrolyzed at temperatures of about 900° C.-1000° C. to produce aluminum. Aluminum electrolysis cells are generally operated within predesignated operating parameters to facilitate efficient aluminum production. There operating parameters generally include one or more of bath temperature, bath superheat, alumina concentration and ratio of sodium fluoride to aluminum fluoride in the bath.

Timely and accurate bath measurements should be completed to facilitate timely and appropriate adjustments to cell inputs (e.g., voltage, alumina feedrate, aluminum fluoride addition). Conventional bath measurement and control procedures are generally slow and complicated. One conventional bath measurement procedure involves manual measurement of bath temperature and/or bath chemistry for an entire cell operating line and/or operating room, followed by manual data entry of the measured operating conditions into a computing device. The computing device then processes the data and may suggest an adjustment to the inputs of the electrolysis cells.

It can take several hours to measure bath temperatures for an entire operating line. Bath chemistry analysis (e.g., analysis of the alumina concentration and ratio of sodium fluoride to aluminum fluoride of the bath) generally requires sampling of the bath followed by laboratory analysis. The laboratory analysis typically takes several hours. Thus, several hours may elapse between measurement of bath temperatures and bath chemistry and entry of the operating condition data into the computer, during which the operating conditions of the electrolysis cells may have dramatically changed. Thus, the computer analysis and corresponding suggested adjustments to the electrolysis cell inputs may be grossly inaccurate, resulting in inefficient operation of the electrolysis cells. There is also an increased likelihood of erroneous data entry using manual techniques. Indeed, the bath sampling procedure provides ample opportunity for inadvertent sample mix-up within the lab followed by mistaken reporting and data entry.

### SUMMARY OF THE INVENTION

In view of the foregoing, a broad objective of the present invention is to facilitate timely and appropriate adjustments of electrolysis cell operating inputs. A related objective is to enable rapid communication of data associated with measured electrolysis cell operating conditions to a computing device.

A further objective is to facilitate an interactive methodology for measuring cell operating conditions and communication of such data to a computing device.

Yet another objective is to facilitate the ready replacement of one or more components of an electrolytic bath measurement device.

In addressing one or more of the above objectives, the present inventors have recognized that a system comprising a bath probe, operable to provide signals relating to one or more operating conditions of an electrolysis cell, and a portable computing device coupled thereto may be utilized to facilitate timely and accurate bath measurements. The portable computing device may determine one or more cell operating conditions based on the provided signals and may provide an output relating to the determined operating conditions to facilitate more timely and appropriate adjustments to the inputs of the electrolysis cell.

In one aspect of the invention, a bath probe may be electrically interconnectable to the portable computing device. In turn, the bath probe may be adapted to provide measurement signals to the portable computing device. The portable computing device may be operable to receive the measurement signals and transform such signals into data. The portable computing device may be operable to provide an output based on the received signals. For example, the portable computing device may compute operating condition information (e.g., bath temperature, bath superheat, bath constituent concentration(s), and/or bath constituent ratio(s)) based on the data.

In one approach, the portable computing device may be operable to output one or more of the data and the operating condition information to a display associated with at least one of the portable computing device and a host computer. In response to the displayed operating condition information, an appropriate action may be determined (e.g., by an operator) with respect to the cell (e.g., adjustment of one or more inputs to the electrolysis cell).

In another approach, the portable computing device may be operable to output one or more of the data and the operating condition information to a host computer, such as via wireless communication. In this approach, one or more of the portable computing device and the host computer may suggest an appropriate action with respect to the cell. In a particular embodiment, the host computer may automatically adjust one or more inputs to the electrolysis cell. Thus, relatively timely and appropriate input adjustment may be facilitated and hence, near real-time measurement and control of cell operating conditions may be achieved.

In one aspect, the bath probe and portable computing device define an analysis system for determining metal electrolysis cell operating conditions and for facilitating a response relative thereto. The bath probe may be electrically interconnectable to a portable computing device. The bath probe may be operable to generate signals associated with at least one operating condition of an electrolysis cell (e.g., temperature measurements produced from thermal communication with a bath of the electrolysis cell). The portable computing device may be operable to receive the generated signals and may be operable to generate data based on the received signals. The portable computing device may be operable to transform the data into operating condition information corresponding with at least one operating condition of the electrolysis cell.

The bath probe may be any suitable bath probe adapted to generate signals associated with an operating condition of the electrolysis cell. For example, the bath probe may comprise a temperature sensor adapted to measure the temperature from thermal communication with a bath of an electrolysis cell. The measured temperatures may be output to the portable computing device in the form signals. In a particular embodiment, the bath probe includes one or more thermocouples adapted to generate a plurality of signals receivable by the portable computing device. The portable computing device may transform the received signals into data corresponding with the measured temperatures. In turn, the portable computing device may utilize such data to calculate at least one cell operating condition, such as bath temperature, bath superheat, bath constituent concentration(s) and/or bath constituent ratio(s), as discussed in further detail below.

One particularly useful bath probe may be a multi-signal bath probe adapted to generate a plurality of signals from thermal communication with a bath of a metal electrolysis cell. In this regard, the bath probe may be adapted to generate first signals (e.g., signals from a thermocouple in thermal communication with a bath sample) and second signals (e.g., signals from a thermocouple in thermal communication with a reference material). Thus, the bath probe may be adapted to generate and provide a plurality of signals, and the portable computing device may receive the generated signals. In turn, the portable computing device may determine (automatically or semi-automatically, such as via prompting using a user interface, discussed below) one or more of bath temperature, bath superheat, bath constituent concentration(s) and/or bath constituent ratio(s) in response to the received signals.

These and other aspects, advantages, and novel features of the invention are set forth in part in the description that follows and will become apparent to those skilled in the art upon examination of the following description and figures, or may be learned by practicing the invention.

### BRIEF DESCRIPTION OF THE DRAWINGS

FIG. 1. is a perspective view of one embodiment of a bath probe system.

FIG. 2. is a block diagram illustrating one embodiment of a communications arrangement useful with the bath probe system of FIG. 1.

FIG. 3. is a block diagram illustrating one embodiment of a method for operating a metal electrolysis cell.

FIG. 4. is a schematic view of one embodiment of a main screen display of the system of the portable computing device of FIG. 1.

FIG. 5. is a schematic view of one embodiment of an electrolysis cell selection screen of the portable computing device of FIG. 1.

FIG. 6. is a schematic view of one embodiment of an electrolysis cell selection screen of the portable computing device of FIG. 1.

FIG. 7. is a schematic view of one embodiment of an electrolysis cell selection screen of the portable computing device of FIG. 1.

FIG. 8. is a schematic view of one embodiment of an indicator screen of the portable computing device in FIG. 1.

FIG. 9. is a schematic view of one embodiment of an indicator screen of the portable computing device in FIG. 1.

FIG. 10. is a schematic view of one embodiment of an indicator screen of the portable computing device in FIG. 1.

FIG. 11. is a schematic view of one embodiment of a result screen of the portable computing device in FIG. 1.

FIG. 12. is a schematic view of one embodiment of a result and indicator screen of the portable computing device in FIG. 1.

FIG. 13. is a schematic view of one embodiment of an indicator screen of the portable computing device in FIG. 1.

FIG. 14. is a schematic view of one embodiment of a coupler of the system of FIG. 1.

### DETAILED DESCRIPTION OF THE INVENTION

Reference will now be made in detail to the accompanying drawings, which at least assist in illustrating various pertinent embodiments of the present invention.

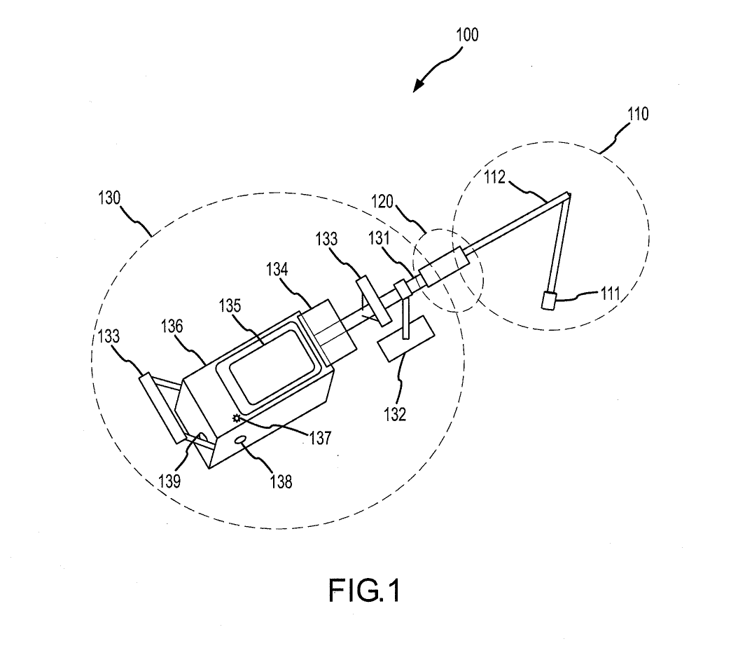

Referring now to FIG. 1, one embodiment of an analysis system 100 is illustrated. The analysis system 100 includes a front end 110 electrically interconnectable to a back end 130 via a coupler 120. The front end 110 includes at least a portion of a bath probe defined at least in part by a probe tip 111 and wires (not illustrated). The probe tip 111 includes at least one temperature sensor (e.g., a thermocouple) that is electrically interconnectable to the back end 130 via wires (not illustrated) disposed within the tip connector 112, the coupler 120, and a lance 131. The probe tip 111 is immersable in a molten bath of an electrolysis cell to facilitate thermal communication between the molten bath and the probe tip. For example, the probe tip 111 may be of the type disclosed by U.S. Pat. No. 6,942,381 to Hosler et al., the disclosure of which is hereby incorporated herein by reference in its entirety. The lance 131 is interconnected to an instrument box 136.

The back end 130 may include a portable computing device 135 that may be mounted to the instrument box 136 to facilitate unitary movement of the system 100. In this regard, the instrument box 136 may include one or more connectors (not illustrated) that restrictively but releaseably engage the portable computing device 135. Thus, assuming appropriate electrical disconnection of the portable computing device 135 from the wires (not illustrated), the portable computing device 135 may be readily and repeatedly physically interconnected and disconnected from the instrument box 136. Thus, selective physical interconnection between the portable computing device 135 and the instrument box 136 may be achieved.

The wires (not illustrated) may terminate proximal the instrument box 136 via an appropriate electrical connector adapted to electrically interconnect with the portable computing device 135. For example, the electrical connector may be a serial port connector and/or a universal serial bus port connector. In one embodiment, the back end 130 is readily electrically interconnectable and disconnectable from the front end 110. Thus, selective electrical interconnection between the portable computing device 135 and the bath probe may be achieved.

The analysis system 100 may include other components, such as handles 133, a stand 132, and/or a screen protector 134 to facilitate movement and protection of the system 100. An indicator light 137 may be provided to indicate one or more events associated with operation of the analysis system 100. For example, the indicator light 137 may indicate the status of a measuring condition, creating data and/or outputting information step, discussed below. A battery recharge port 138 may also be included to facilitate recharging of the batteries of the analysis system 100. A power switch 139 may be included to facilitate powering on and off of the portable computing device 135.

As noted, the portable computing device 135 is operable to generate data in response to the signals from the bath probe and output information to facilitate a control response with respect to the electrolysis cell. Particularly, the portable computing device 135 may utilize the generated data to create information corresponding with one or more operating conditions of the electrolysis cell (“OC information”). For example, the portable computing device 135 may calculate the bath temperature, bath superheat, bath constituent concentration(s) and/or the bath constituent ratio(s), such as by using first signals associated with temperatures of a bath sample and second signals associated with a reference member of a bath probe 110. The bath constituent concentration(s) may be one or more of a concentration of a metal oxide constituent, a metal constituent, a diluent constituent or other constituent(s). Correspondingly, the bath constituent ratio(s) may be one the ratio(s) of any constituent of the bath. In a particularly preferred embodiment, the bath constituent concentration is the concentration of the metal oxide within the bath (e.g., alumina) and the bath constituent ratio is the ratio of an metal salt to an additive within the bath (e.g., ratio of sodium fluoride to aluminum fluoride). Many of such operating conditions may be determined using this two signal technique as described in U.S. Pat. No. 6,942,381, which is hereby incorporated herein by reference in its entirety.

In one approach, the portable computing device 135 may display the OC information and/or display a suggest course of action based upon such OC information via a display associated with the portable computing device 135. For example, if the portable computing device 135 is a laptop computer, the corresponding laptop display screen may be utilized to display the OC information and/or the suggested course of action, wherein a person may review such OC information and/or suggested course of action to determine a timely and appropriate control response.

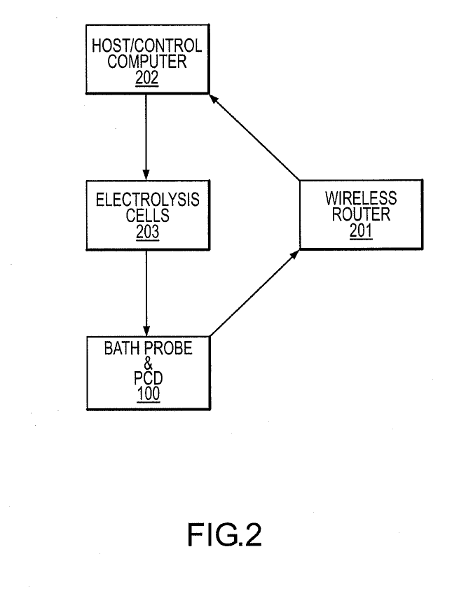

One communication scheme useful with the analysis system 100 is illustrated in FIG. 2. In this embodiment, an analysis system 100 may be electrically interconnectable to another computer, such as a host computer 202 adapted to control one or more operating inputs to an electrolysis cell 203, wherein the data and/or OC information produced by the analysis system 100 is output (e.g., wirelessly transferred via wireless router 201) to the host computer 202 for further processing and/or output. In one embodiment, the host computer 202 receives the data and/or OC information from the analysis system 100 and outputs such OC information and/or a suggested course of action. For example, the host computer 202 may display one or more of the OC information and/or suggested course of action on a display associated with the host computer 202. In another embodiment, the host computer 202 receives the data and/or OC information from the analysis system 100 and automatically adjusts one or more inputs of an electrolysis cell 203 (e.g., voltage input, alumina feed rate, aluminum fluoride addition).

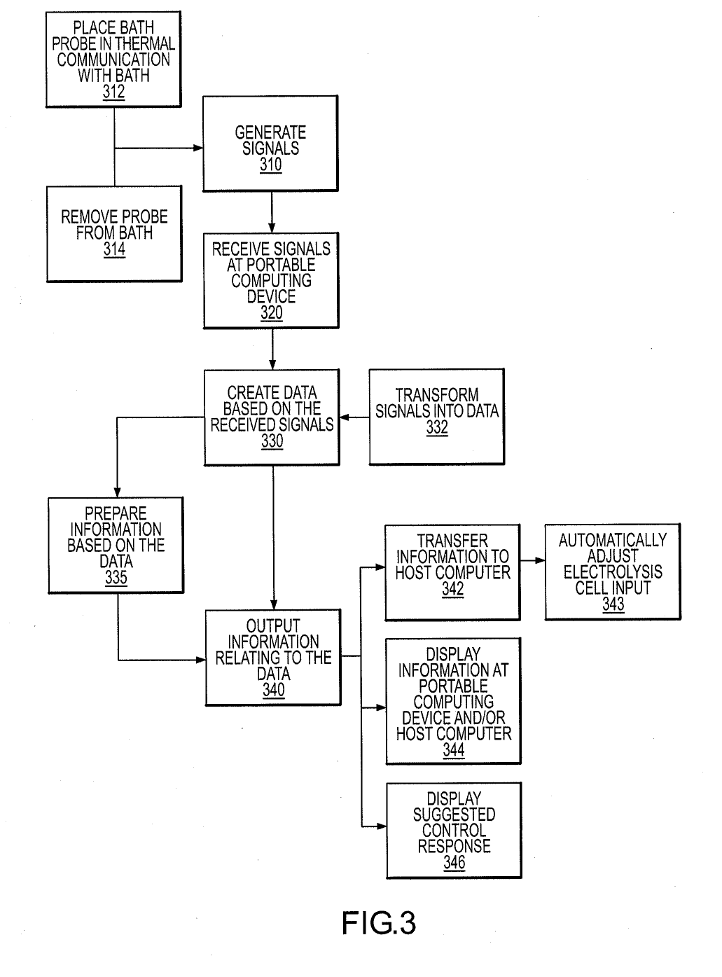

Methods for operating metal electrolysis cells are also provided. One embodiment of a method for operating metal electrolysis cells is illustrated in FIG. 3. In this embodiment, the method includes the steps of generating signals relating to at least one operating condition of an electrolysis cell (310), receiving the signals at a portable computing device (320), creating data (e.g., digital data) based on the received signals (330), and outputting information corresponding with the data to facilitate a control response (340). The outputted information may be OC information, as described above, the created data, or may be information corresponding with a suggest course of action.

The creating data step (330) may include the step of transforming the received signals into data (332). In this regard, various known analog to digital transformation techniques may be used, such as techniques associated with conversion of voltage signals from a thermocouple into corresponding temperature measurement data.

The outputting information step (340) may be accomplished in a variety of manners. For example, the information may be displayed on a display associated with one or more of the portable computing device and/or a host computer (344), as described above. In another approach, the information is outputted via transfer (342) to a host computer for further processing and/or output. In one embodiment, the information may be wirelessly transferred to the host computer. In this embodiment, the portable computing device may be located in the pot room (i.e., a first location) and the host computer may be located in an operation room / control room located outside of the pot room (i.e., at a second location remote from the first location). Thus, expedited control decisions may be facilitated, thereby increasing the likelihood of appropriate adjustment(s) to electrolysis cell inputs. In another embodiment, the portable computing device may be physically disconnected from the system and transported to another location, where it may be electrically interconnected to the host computer for communication therewith (e.g., via one or more wires/ports). The outputting information step (340) may also include the step(s) of displaying a suggested control response (346) at the portable computing device and/or host computer.

The method may also include the step of preparing information (335) based on the data. In this regard, the data may be analyzed and/or transformed to determine the information, such as by the portable computing device and/or a host computer. The information may then be utilized to facilitate a control response, as noted above.

The method may also include the step of placing a bath probe in thermal communication with a bath (312) of an electrolysis cell (e.g., via immersion of the probe tip in the bath). In this approach, the generating step may include the step of removing the bath probe from substantial thermal communication with the bath (314). During or after the removing step, signals from the bath probe may be generated and sent to the portable computing device to facilitate the creating data step. The bath probe may be removed from substantial thermal communication with the bath for a predetermined temperature range, after which thermal communication may be reestablished between the bath probe and the bath to facilitate removal of bath sample located within the bath probe. For example, in aluminum electrolysis cells, the bath probe may be removed from thermal communication with the bath until the measured bath sample temperature reaches a temperature of not greater than 700° C., such as not greater than 650° C. or even not greater than 400° C.

As noted, the present systems and methods facilitate timely and accurate bath condition measurements and corresponding timely and appropriate adjustments to one or more electrolysis cell inputs. For example, the duration between the start of the time the bath probe is placed in thermal communication with the bath to the time information is output by the portable computing device may be relatively short, such as not greater than 60 minutes, preferably not greater than 45 minutes, and even more preferably not greater than 30 minutes. In some instances, the duration between the start of the placing step and the outputting information step is relatively short, such as not greater than 10 minutes or even not greater than 5 minutes. As noted above, expedited and appropriate adjustments to electrolysis cell inputs may thus be facilitated, especially when a portable computing device is wirelessly interconnected with a host computer. Hence, near-real time control of electrolysis cells may be facilitated.

As noted above, one objective of the present invention is to facilitate an interactive measurement sequence and/or an interactive data and/or OC information review. One embodiment of an interactive sequence is described below utilizing a portable digital assistant (PDA) operating on Microsoft WINDOWS software. However, other portable computing devices (e.g., a laptop computer) or other operating systems (e.g., Linux, Macintosh) may be utilized.

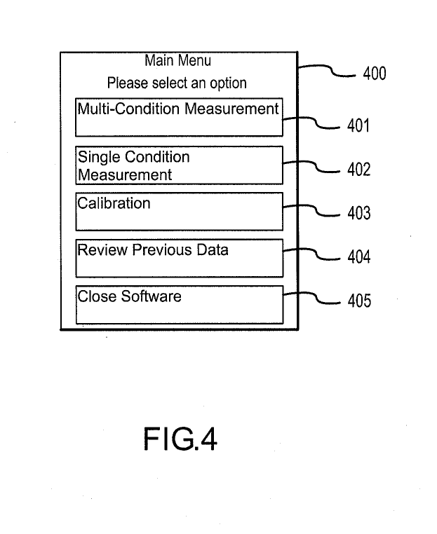

After the operating system of the portable computing device has been initiated, the software associated with the portable computing device 135 may be initiated. One example of a main screen display associated with the analysis system 100 and measurement of cell operating conditions is illustrated in FIG. 4.

In the illustrated embodiment, the main screen display 400 comprises a plurality of buttons, such as a multi-condition measurement button 401, a single condition measurement button 402, a calibration button 403, a review previous data button 404, and a close software button 405.

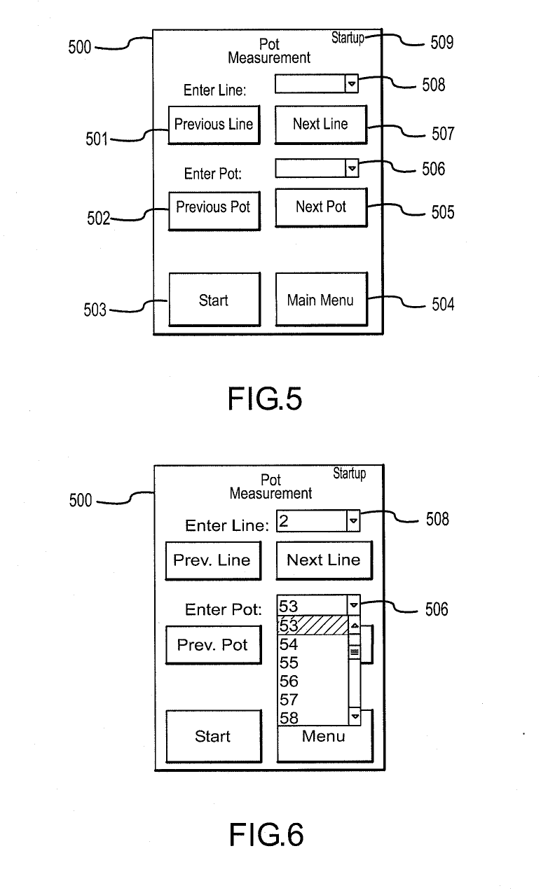

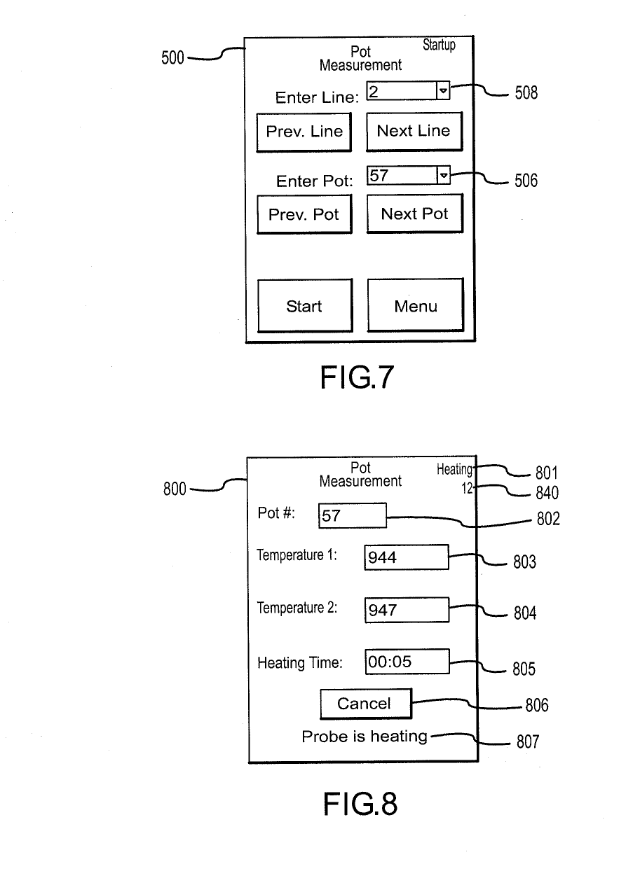

The multi-condition measurement button 401 may initiate software that enables the user to measure a plurality of operating conditions of the electrolysis cell. By selecting this option (e.g., via a touch-screen), a second screen may be illustrated, such as an electrolysis cell selection screen, which may prompt a user to select an electrolysis cell (e.g., a “pot”) for measurement. Examples of such electrolysis cell selection screens are illustrated in FIGS. 5-7. In these examples, the user may select an appropriate line via drop-down button 508 and pot number via drop-down button 506 for measurement. Alternatively, the “Next Pot” 505, “Prev. Pot” 502, “Next Line” 507 and/or “Prev. Line” 501 buttons may be utilized to facilitate and expedite measurement of adjacent pots. A textural display 509 may be used to display the status/operation step associated with the analysis system 100.

In another embodiment, each of the electrolysis cells may be associated with a unique transmitter (e.g., an RFID tag) and the personal computing device may be operable to receive signals from each of the transmitters and automatically select an electrolysis cell for measurement once the personal computing device is within a predetermined distance of the unique transmitter. A user may then confirm the identity of the automatically selected electrolysis cell. Once both the electrolysis cell identity has been entered/confirmed and the bath probe tip is immersed in that electrolysis cell, the “Start” button 503 may be utilized to initiate the measurement process. A main menu button 504 may be utilized to return to main menu screen 400.

During measurement, one or more indicator screens may be utilized to indicate the status of the measurement operation to a user. For example, an indicator screen may indicate the status of bath probe 110 warm-up. Examples of such screens are illustrated in FIGS. 8-10.

In the illustrated embodiments, the indicator screen 800 may indicate the pot number 802, the current temperature(s) 803, 804 associated with the probe tip and the elapsed heating time 805. The indicator screen 800 may further indicate the status of the measurement operation via one or more textural displays 801, 807. In the illustrated example, the textural displays 801, 807 indicate that the bath probe is heating, thereby indicating to a user that action with request to the probe and personal computing device is not required at that time. Elapsed time (e.g., seconds) may be displayed via textural indicator 840. The indicator screen 800 may enable the user to cancel the operation via the “cancel” button 806, wherein the software may return to the electrolysis cell selection screen 500.

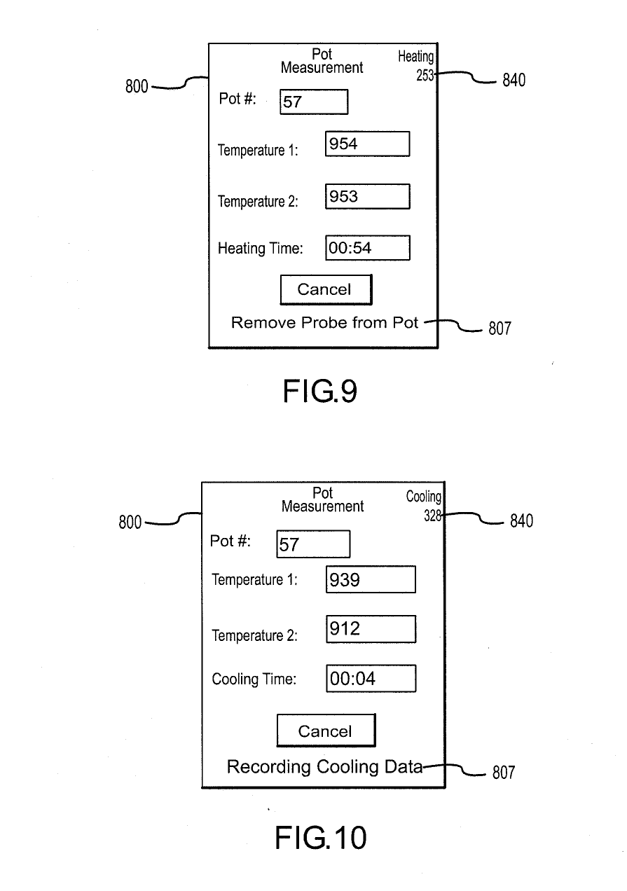

Once the probe tip temperature is about equivalent to the bath temperature of the electrolysis cell, an indicator may be provided to a user. For example, the indicator light 137, described above, may provide a visual indicator (e.g., a color indicator, a blinking indicator) that the probe tip and the electrolytic bath are at about equivalent temperatures. An audible indicator may be provided by a portable computing device to indicate that the probe tip and the electrolytic bath are at about equivalent temperatures. A visual indicator of the portable computing device may be used, such as via an indicator screen to indicate that the probe tip and the electrolytic bath are at about equivalent temperatures. One embodiment of such a portable computing device visual indicator is illustrated in FIG. 9, wherein textual display 807 indicates to a user that the probe tip should be removed from the bath.

After the user has removed the probe tip from the bath, an indicator may be provided to indicate the status of the measurement operation. For example and with reference to FIG. 10, the screen 800 may provide a textual display 807 to the user indicating that the analysis system is measuring and recording data.

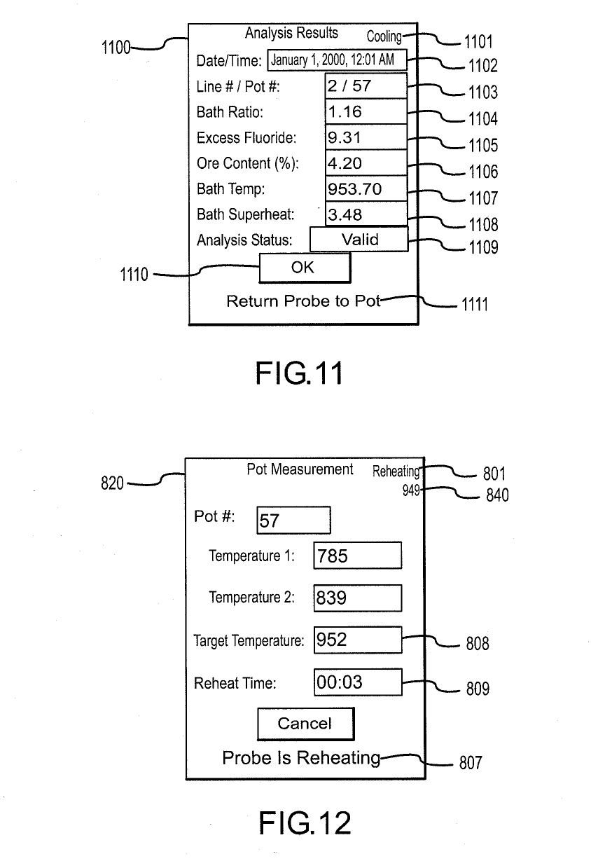

After the system achieves a predetermined condition (e.g., the temperature of the probe tip reaches a predetermined temperature), an output may be automatically provided to a user. For example, and with reference to FIG. 11, the portable computing device may automatically display a result screen 1100. In the illustrated embodiment, the result screen includes a status indicator 1101, which indicates the status of the analysis system, a date time indicator 1102, which indicates the date and/or time the measurements were taken/determined, a line number/pot number indicator 1103, which indicates the line and/or cell pot for which the measurements were taken/determined, a bath ratio indicator 1104, which indicates the determined bath ratio, an excess fluoride indicator 1105, which indicates the determined amount of excess fluoride in the bath, an ore content percent indicator 1106, which indicates the determined amount of ore (e.g., alumina) in the bath, a bath temperature indicator 1107, which indicates the determined temperature of the bath, a bath superheat indicator 1108, which indicates the determined superheat of the bath, an analysis status indicator 1109, which indicates whether the analysis was successfully indicates, a button 1110 for acknowledging that the results have been viewed and/or for returning to a prior screen, and a instruction indicator 1111, which indicates a suggested next action.

Also/alternatively, the portable computing device may automatically, or via prompting, communicate the results via wireless communication to a host computer, whereupon the host computer may automatically make a control decision with respect to the electrolysis cell and/or display the results for determination of an appropriate control response and/or suggest an appropriate control response.

After the measurement results have been output, the probe tip may be reimmersed into the same electrolytic pot bath to reheat the probe tip and facilitate removal of residual bath sample from the probe tip. During this reheating, an indicator may be provided to indicate the status of the reheating. For example and with reference to FIG. 12, the screen 820 may provide textual displays 801, 807 to the user indicating that the system is reheating the probe tip. Screen 820 is similar to screen 800, above, except that heating time display 805 has been replaced by a target temperature display 808 and a reheat time display 809.

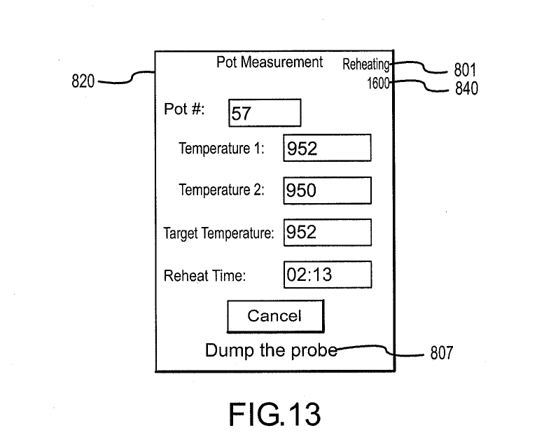

After the probe tip 111 has reached a predetermined reheat temperature, an indicator may be provide to indicate that the probe tip should be physically manipulated to empty the bath sample located therein. For example and with reference to FIG. 13, the screen 800 may display a textual indicator 807 indicating that a user should remove the sample from the probe tip.

After the sample has been removed from the probe tip, the portable computing device may automatically display a previous screen to facilitate measurement of another electrolysis cell (e.g., the main menu 400 screen or the electrolysis cell selection screen 500). Alternatively, a user may review previously collected data (e.g., via the review previous data button 404 and associated screens). In this regard, the portable computing device may output specific textual and/or graphical data associated with one or more electrolysis cell measurements. A user may make a control decision with respect to one or more electrolysis cells in response to such output from the portable computing device.

With reference back to the main menu screen 400 (FIG. 4), a user may select the single condition measurement 402 (e.g., when cell operating conditions can be calculated from bath superheat) to facilitate determining of the operation status of an electrolysis cell. Similar procedures and indicators to those described above may be utilized during the single condition measurement operation. However, the single condition measurement operation may take significantly less time (e.g., not greater than about 30 seconds after the sample is removed from the pot via the probe tip) to provide an output as compared to the multi condition measurement (e.g., not greater than about 5 minutes after the sample is removed from the pot via the probe tip 111). The probe tip and portable computing device may also be calibrated using the portable computing device (e.g., via calibration button 403 and associated screen). A user may also close/shut-down the probe software from the main screen (e.g., via close button 405).

The above interactive system and methods, and variations thereof, are particularly useful in facilitating measurement and analysis of cell operating conditions. With particular reference to FIG. 3, expedited generating (310), creating (330) and outputting (340) steps may be realized with the use of such inventive interactive systems and methods. Moreover, restricted operator error may be realized.

The probe tip of the bath probe may require frequent replacement, such as after one-hundred or more uses or after inadvertent contact with an undesired portion of the electrolysis cell and/or electrolysis cell bath. To facilitate the quick removal of the probe tip, two sets of wires may be utilized in conjunction with one or more wire connectors to interconnect the probe tip to a signal recipient, wherein the wire set associated with the probe tip could be readily removed via the one or more wire connectors.

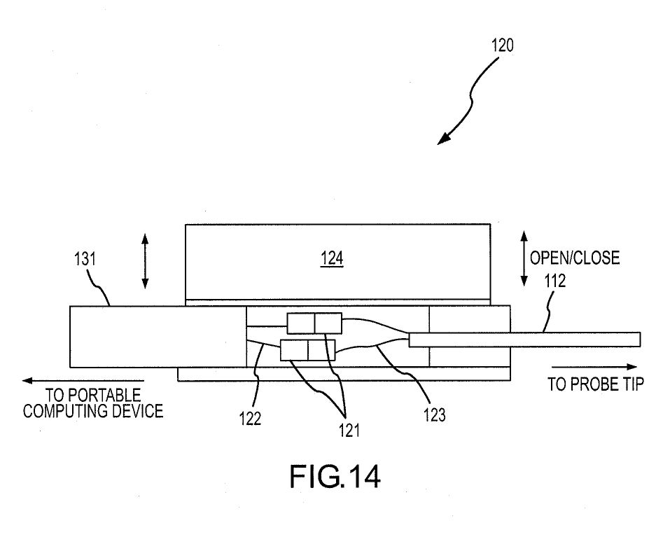

More particularly and with reference to FIG. 14, the coupler 120 may include wire connectors 121 adapted to repeatedly and readily connect and disconnect a first set of wires 122 associated with the analysis system 100 from a second set of wires 123. A cover 124 may be used to provide access to connectors 121. Thus, probe tip may be readily disconnected from the analysis system to facilitate replacement, such as after its useful lifetime has expired.

The portable computing device may also be repeatedly and readily removed from the analysis system 100, such as when it is desirable to interconnect it to a remote host computer. In another embodiment, and as noted above, the wires 122 may be terminate via another connector at the instrument box 136 (e.g., a serial port connector, a USB port connector). Thus, the portable computing device 135 may be repeatedly and readily interconnected with and disconnected from the system 100 without requiring disconnection of the wires 122, 123 from the probe tip.

The analysis system may be fabricated to facilitate measurement of many different electrolysis cells. For example, the system may stand on a deck plate or the operating room floor when the probe tip is placed in the electrolysis cell bath. Alternatively, the system can be integrated with a cart support, wherein the analysis system 100 hangs from the cart for portable movement about the operating room. Use of the analysis system with other types of metal electrolysis cells, such as magnesium, may also be possible.

As may be appreciated, many of the above-described systems may be utilized in conjunction with many of the above-described methods, and vice-versa, and any of such useful combinations are expressly within the scope and spirit the present invention. Moreover, while various approaches, aspects, embodiments and otherwise of the present invention have been described in detail, it is apparent that modifications and adaptations of those embodiments will occur to those skilled in the art. However, it is to be expressly understood that such modifications and adaptations are within the spirit and scope of present invention.

What is claimed is:

1. A system for determining one or more operating conditions of a metal electrolysis cell and facilitating a response relative thereto, the system comprising:
a bath probe comprising a probe tip and wires connected to the probe tip; and
a portable computing device electrically interconnectable to the bath probe via the wires; wherein the bath probe is operable to generate signals associated with temperature measurements produced from thermal communication with a bath of the electrolysis cell, wherein the portable computing device is operable to receive the signals and generate data based on the received signals, wherein the portable computing device is further operable to transform the data into operating condition information associated with at least one operating condition of the electrolysis cell.

2. The system of claim 1, wherein the portable computing device is operable to transmit at least one of the data and the operating condition information to a host computer electrically interconnectable to the portable computing device.

3. The system of claim 2, wherein the operating condition information is bath superheat.

4. The system of claim 2, wherein the operating condition information comprises at least two of bath temperature, bath superheat, a bath constituent concentration and a bath constituent ratio.

5. The system of claim 4, wherein the metal electrolysis cell is an aluminum electrolysis cell, wherein the bath constituent concentration is the concentration of alumina and wherein the bath constituent ratio is the ratio of sodium fluoride to aluminum fluoride.

6. The system of claim 2, wherein the host computer is operable to display a suggested course of action based on the operating condition information.

7. The system of claim 1, wherein the portable computing device is operable to display at least one of the data and the operating condition information.

8. The system of claim 1, wherein the portable computing device is electrically interconnectable to the bath probe via (i) a first set of wires interconnectable to the portable computing device, (ii) a second set of wires interconnectable to the bath probe and (iii) a wire connector interconnectable to the first and second set of wires.

9. The system of claim 8, wherein the bath probe comprises:
a probe tip comprising a temperature sensor, wherein the temperature sensor is electrically interconnectable to the portable computing device via the first set and the second set of wires and the wire connector.

10. A method for operating a metal electrolysis cell, the method comprising:
generating signals relating to at least one operating condition of the electrolysis cell;
receiving the signals at portable computing device;
creating data associated with the signals; and
outputting operating condition information corresponding with the data to facilitate a control response.

11. The method of claim 10, wherein the operating condition information corresponds with the at least one operating condition and wherein the at least one operating condition is at least one of bath temperature, bath superheat, bath metal oxide concentration, and bath constituent ratio.

12. The method of claim 10, wherein the outputting step comprises:
transferring at least one of the data and the operating condition information to a host computer.

13. The method of claim 10, wherein the outputting step comprises:
displaying the operating condition information on a display associated with the portable computing device.

14. The method of claim 10, further comprising:
placing a bath probe in thermal communication with a bath of the electrolysis cell; wherein the generating step comprises:
removing the bath probe from substantial thermal communication with the bath for a predetermined temperature range.

15. The method of claim 15, wherein the placing step occurs before the outputting step and wherein the duration between the start of the placing step and the end of the outputting step is not greater than one hour.

16. The method of claim 10, wherein the creating step occurs at a first location and wherein the outputting step occurs at a second location remote from the first location.

17. The method of claim 16, wherein the first location is the operating room of the electrolysis cell and wherein the second location is located outside the operating room.

18. The method of claim 10, wherein the outputting step comprises:
displaying a recommended control response on a display associated with at least one of the portable computing device and a host computer.

19. The method of claim 10, further comprising:
automatically completing an action in response to the outputting step.

20. The method of claim 19, wherein the automatically completing step comprises:
adjusting one or more of a voltage output and a constituent feedrate associated with the electrolysis cell.
